(19) United States
(12) Patent Application Publication
(10) Pub. No.: US 2014/0040082 A1
(43) Pub. Date: Feb. 6, 2014

(54) FLEXIBLE EXPOSURE LIFECYCLE MANAGEMENT

(71) Applicants: Klaus Mueller, Neustadt (DE); Andy Peichl, Ubstadt-Weiher (DE); Sebastian Noetzel, Mannheim (DE)

(72) Inventors: Klaus Mueller, Neustadt (DE); Andy Peichl, Ubstadt-Weiher (DE); Sebastian Noetzel, Mannheim (DE)

(73) Assignee: SAP AG, Walldorf (DE)

(21) Appl. No.: 13/734,272

(22) Filed: Jan. 4, 2013

Related U.S. Application Data
(60) Provisional application No. 61/679,338, filed on Aug. 3, 2012.

(51) Int. Cl. G06Q 40/00

(52) U.S. Cl. CPC G06Q 40/10
USPC 705/30

(57) ABSTRACT

The disclosure generally describes computer-implemented methods, computer-readable media, and computer systems for flexible exposure lifecycle management. One computer-implemented method includes defining at least one custom exposure lifecycle, wherein the at least one custom exposure lifecycle includes at least one custom exposure category and at least one custom exposure activity, receiving exposure category data associated with the at least one custom exposure category, receiving exposure activity data associated with the at least one custom exposure activity, mapping, by operation of at least one computer, the received exposure category data with one of a required set of transaction categories associated with a required exposure lifecycle, and mapping, by operation of at least one computer, the received exposure activity data with one of a required set of transaction activities associated with the required exposure lifecycle.

This application claims priority under 35 U.S.C. §119(e) to U.S. Provisional Patent Application Ser. No. 61/679,338, filed on Aug. 3, 2012. The entire contents of U.S. Provisional Patent Application Ser. No. 61/679,338 are hereby incorporated by reference.

### BACKGROUND

The present disclosure relates to computer-implemented methods, computer-readable media, and computer systems for flexible exposure lifecycle management. Existing exposure management applications support a fixed exposure hedge accounting lifecycle with fixed categories modeled according to international accounting standards (IAS) board “IAS 39: Financial Instruments: Recognition and Measurement” accounting standards. The fixed lifecycle and fixed exposure transaction categories do not allow definition of additional exposure transaction categories to structure exposure reporting according to individual needs and/or to extend the lifecycle of an exposure with additional steps. This lack of flexibility adversely affects efficiency and cost of compliance with the IAS 39 accounting standard rules for exposure management as well as introducing inaccuracy into exposure reporting.

### SUMMARY

The present disclosure relates to computer-implemented methods, computer-readable media, and computer systems for flexible exposure lifecycle management. One computer-implemented method includes defining at least one custom exposure lifecycle, wherein the at least one custom exposure lifecycle includes at least one custom exposure category and at least one custom exposure activity, receiving exposure category data associated with the at least one custom exposure category, receiving exposure activity data associated with the at least one custom exposure activity, mapping, by operation of at least one computer, the received exposure category data with one of a required set of transaction categories associated with a required exposure lifecycle, and mapping, by operation of at least one computer, the received exposure activity data with one of a required set of transaction activities associated with the required exposure lifecycle.

Other implementations of this aspect include corresponding computer systems, apparatuses, and computer programs recorded on one or more computer-readable media, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by a data processing apparatus, cause the apparatus to perform the actions.

The foregoing and other implementations can each optionally include one or more of the following features:

A first aspect, combinable with the general implementation, wherein the at least one custom exposure lifecycle includes more or less exposure lifecycle steps than required by the required exposure lifecycle.

A second aspect, combinable with any of the previous aspects, wherein the at least one custom exposure lifecycle is defined for a particular risk category.

A third aspect, combinable with any of the previous aspects, wherein the at least one custom exposure lifecycle is one of a plurality of custom exposure lifecycles defined for a particular operational lifecycle.

A fourth aspect, combinable with any of the previous aspects, further comprising merging the plurality of custom exposure lifecycles into the required exposure lifecycle.

A fifth aspect, combinable with any of the previous aspects, further comprising determining whether data entry is complete for the custom exposure lifecycle.

A sixth aspect, combinable with any of the previous aspects, wherein mapping is performed utilizing at least one of a mapping table, a mapping application, or customizable parameters.

The subject matter described in this specification can be implemented in particular implementations so as to realize one or more of the following advantages. First, the exposure lifecycle can be customized and modeled (flexible transaction categories/activities may be defined) according to a user's needs yet the use of the customized lifecycle will still satisfy legal and regulatory requirements. Second, individual transaction categories/activities can be linked together. For different types of risks, individual sequences of categories can be defined and used to describe the exposure lifecycle. Third, customized transaction categories/activities may be matched/mapped to the established legally defined transaction categories/activities of IAS 39. Other advantages will be apparent to those skilled in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example system for flexible exposure lifecycle management.

FIG. 2 is a block diagram illustrating a fixed exposure lifecycle of required exposure categories and associated exposure activities defined by international accounting standards (IAS) board “IAS 39: Financial Instruments: Recognition and Measurement” accounting standards.

FIG. 3 is a block diagram illustrating custom exposure lifecycles defined for different risk categories.

FIG. 4 is a block diagram illustrating a model lifecycle of exposures represented by a data model.

FIG. 5 is a block diagram illustrating an example mapping of an operational lifecycle to a required exposure lifecycle.

FIG. 6 is a flow chart of a method for flexible exposure lifecycle management.

Like reference numbers and designations in the various drawings indicate like elements.

### DETAILED DESCRIPTION

The disclosure generally describes computer-implemented methods, computer-readable media, and computer systems for flexible exposure lifecycle management.

For the purposes of this disclosure, an enterprise resource planning (ERP) system integrates both internal and external organizational management information across the entire organization. ERP system applications assist the organization to manage financial/accounting, manufacturing, sales and service, customer relationship management, human resources, and other suitable functions and enable the flow of information between all business functions of the organization. The ERP is designed to aggregate, synthesize, and personalize information for organizational stakeholders who can use the presented information to make decisions for the organization. One ERP financial/accounting application may provide legal/regulatory required exposure management in compliance with established accounting rules for derivative financial instruments used to hedge exposure to different financial risks, for example interest rate risk, foreign exchange risk, commodity risk, and other suitable financial risks.

Existing exposure management applications support a fixed exposure hedge accounting lifecycle with fixed categories modeled according to international accounting standards (IAS) board “IAS 39: Financial Instruments: Recognition and Measurement” accounting standards. The fixed lifecycle and fixed exposure transaction categories do not allow definition of additional exposure transaction categories to structure exposure reporting according to individual needs and/or to extend the exposure lifecycle with additional steps. This lack of flexibility adversely affects efficiency and cost of compliance with the IAS 39 accounting standard rules for exposure management as well as introducing inaccuracy into exposure reporting. The disclosure describes the ability to flexibly define custom exposure transaction categories and modeling of custom exposure lifecycles to enhance overall exposure management. The custom exposure transaction categories can be defined and linked together to form a particular exposure lifecycle for each type of financial risk. This flexibility permits exposure management according to individual business needs yet fulfilling legal requirements by mapping each custom exposure category to the IAS 39 defined fixed exposure transaction categories in order to comply with the IAS 39 reporting requirements.

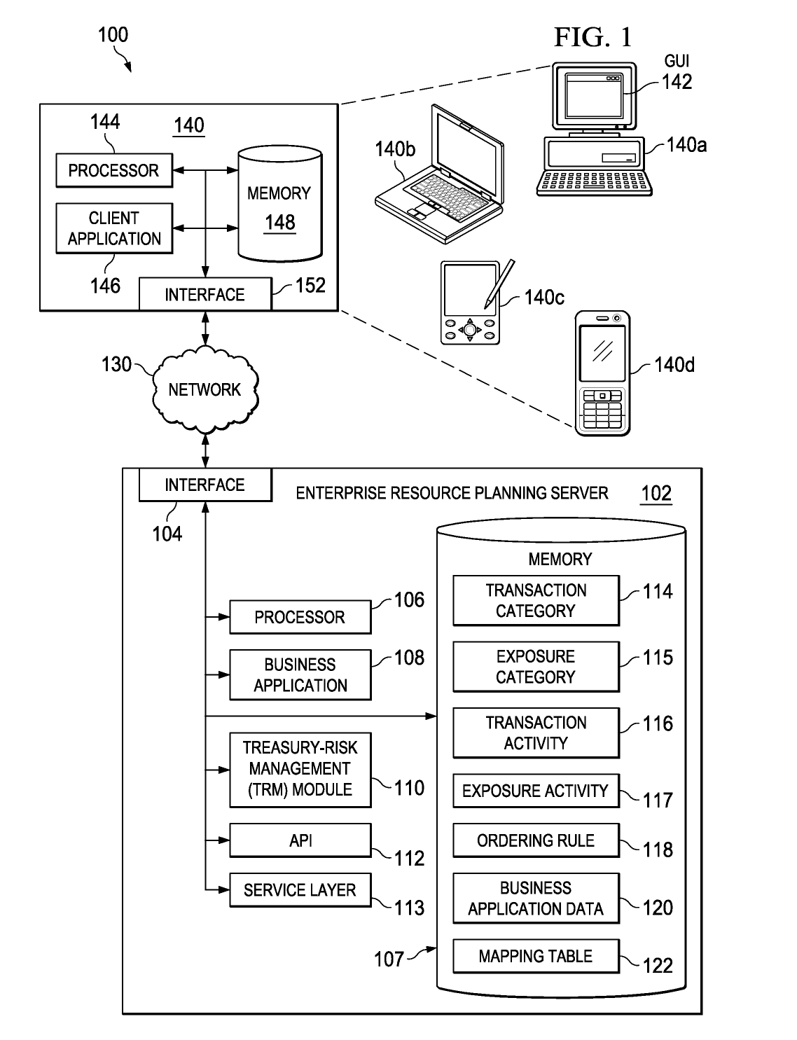

FIG. 1 illustrates an example distributed computing system 100 for flexible exposure lifecycle management. At a high-level, the illustrated example distributed computing system 100 includes or is communicably coupled with an ERP server 102 and clients 140a-140d (collectively client 140) that communicate across a network 130. The enterprise resource planning (ERP) server 102 comprises a computer operable to receive, transmit, process, store, or manage data and information associated with the example distributed computing system 100. In general, the ERP server 102 is a server that stores a business application 108 and a treasury-risk management module 110, where at least a portion of the business application 108 and/or the treasury-risk management module 110 is executed using requests and responses sent to a client 140 within and communicably coupled to the illustrated example distributed computing system 100 across network 130. The business application 108 and/or treasury-risk management module 110 are used to ensure flexible exposure lifecycle management. In some implementations, the ERP server 102 may store a plurality of various business applications 108 and/or treasury-risk management modules 110. In other implementations, the ERP server 102 may be a dedicated server meant to store and execute only a single business application 108 and/or a treasury-risk management module 110. In still other implementations, the enterprise server can store and execute none, a single instance, and/or a plurality of the business application 108 and/or the treasury-risk management module 110. In some implementations, the ERP server 102 may comprise a web server, where the business application 108 and/or the treasury-risk management module 110 represents one or more web-based applications accessed and executed by the client 140 using the network 130 or directly at the ERP server 102 to perform the programmed tasks or operations of the business application 108 and/or the treasury-risk management module 110.

Specifically, the ERP server 102 is responsible for receiving application requests, for example requests for flexible exposure lifecycle management, from one or more client applications (described below) associated with the client 140 of the example distributed computing system 100 and responding to the received requests by processing said requests in the associated business application 108 and/or treasury-risk management module 110, and sending an appropriate response from the business application 108 and/or treasury-risk management module 110 back to the requesting client application. In addition to requests from the client 140, requests associated with the business application 108 and/or treasury-risk management module 110 may also be sent from internal users, external or third-party customers, other automated applications, as well as any other appropriate entities, individuals, systems, or computers. According to one implementation, ERP server 102 may also include or be communicably coupled with an e-mail server, a web server, a caching server, a streaming data server, and/or other suitable server. In other implementations, the ERP server 102 and related functionality may be provided in a cloud-computing environment.

The ERP server 102 includes an interface 104. Although illustrated as a single interface 104 in FIG. 1, two or more interfaces 104 may be used according to particular needs, desires, or particular implementations of the example distributed computing system 100. The interface 104 is used by the ERP server 102 for communicating with other systems in a distributed environment—including within the example distributed computing system 100—connected to the network 130; for example, the client 140 as well as other systems communicably coupled to the network 130 (not illustrated). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated example distributed computing system 100.

The ERP server 102 includes a processor 106. Although illustrated as a single processor 106 in FIG. 1, two or more processors may be used according to particular needs, desires, or particular implementations of the example distributed computing system 100. Generally, the processor 106 executes instructions and manipulates data to perform the operations of the ERP server 102. Specifically, the processor 106 executes the functionality required to receive and respond to requests from the client 140 and/or provide for flexible exposure lifecycle management.

The ERP server 102 also includes a memory 107 that holds data for the ERP server 102. Although illustrated as a single memory 107 in FIG. 1, two or more memories may be used according to particular needs, desires, or particular implementations of the example distributed computing system 100. While memory 107 is illustrated as an integral component of the ERP server 102, in alternative implementations, memory 107 can be external to the ERP server 102 and/or the example distributed computing system 100. In some implementations, the memory 107 includes at least of a transaction category 114, an exposure category 115, a transaction activity 116, an exposure activity 117, an ordering rule 118, business application data 120, and/or mapping table 122.

The transaction category 114 defines a required category of transaction engaged in by a business entity. For example, a forecasted transaction, a firm commitment, or an asset/liability as required by IAS 39. The exposure category 115 may define a custom category of a transaction engaged in by a business entity. For example, “Stock/Cash,” “myVariable Firm C *,” etc. The exposure category 115 may be the same as or different from a transaction category 114. This allows transactions to be better defined for a business entity's use. The exposure categories 115 are eventually mapped to a particular transaction category 114. In some implementations, multiple transaction categories 114 and/or exposure categories 115 may be arranged in a hierarchical relationship where some transaction categories 114/exposure categories 115 can be deemed subordinate, equal, and/or superordinate to other transaction categories 114/exposure categories 115.

The transaction activity 116 may define a required activity engaged in by a business entity and associated with a particular exposure category 114. The transaction activity 116 further details a transaction associated with a transaction category 114. For example, transaction activities 116 associated with a “Forecasted Transaction” transaction category 114 may include “sale” and “purchase” as required by IAS 39. “Sale” or “purchase” detail a particular instance of a forecasted transaction transaction category 114 as a sale or purchase. The exposure activity 117 may define a custom activity of a transaction engaged in by a business entity. The exposure activity 117 may be the same as or different from a transaction activity 116. This allows transactions to be better defined for a business entity's use. The exposure activities 117 are eventually mapped to a particular transaction activity 116. In some implementations, multiple transaction activities 116 and/or exposure activities 117 may be arranged in a hierarchical relationship where some transaction activities 116/exposure activities 117 can be deemed subordinate, equal, and/or superordinate to other transaction activities 116/exposure activities 117.

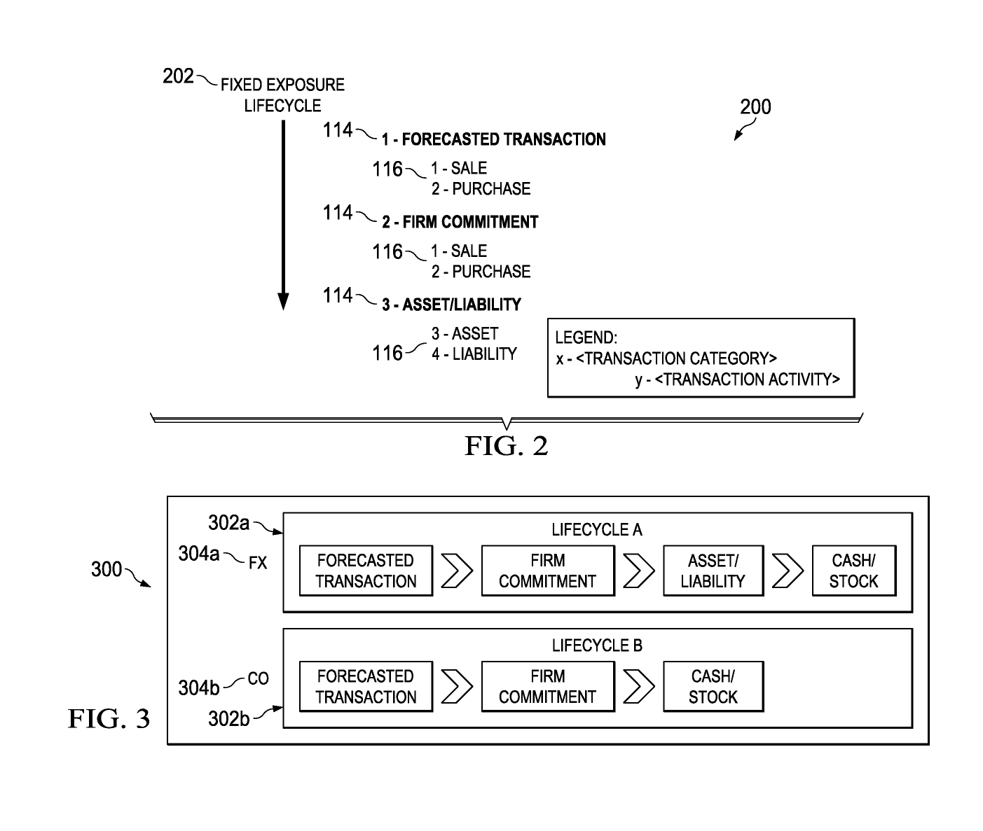

Referring to FIG. 2, FIG. 2 is a block diagram 200 illustrating a fixed exposure lifecycle 202 of required transaction categories 114 and associated transaction activities 116 defined by international accounting standards (IAS) board “IAS 39: Financial Instruments: Recognition and Measurement” accounting standards. The illustrated transaction categories 114 are: 1—Forecasted Transaction; 2—Firm Commitment; and 3—Asset/Liability along with transaction activities 116 1—Sale/2—Purchase, 1—Sale/2—Purchase, and 3—Asset/4—Liability for each transaction category 114, respectively.

Also illustrated is the IAS 39 required fixed exposure lifecycle 202. The exposure lifecycle 202 is a series of consecutive and successive transaction categories 114/associated transaction activities 116. The illustrated IAS 39 fixed exposure lifecycle 202 requires that data for the transaction categories 114/associated transaction activities 116 be entered for each transaction category 114 (and associated transaction activities 116) in the order shown, that is first for 1—Forcasted Transaction, 2—Firm Commitment, and finally 3—Asset/Liability and subsequently processed for use by each successive transaction category 114 and transaction activity 116.

The fixed exposure lifecycle 202 can cause issues with mapping data to the provided transaction categories 114 and associated transaction activities 116. For example, with respect to exposure management functions and hedge management functions, transaction activities 116 for “1—Sale” and “2—Purchase” have different meanings. As another example, the transaction category 114 “2—Firm Commitment” has a different meaning between exposure management and hedge management functions.

While this disclosure discusses transaction category 114 and transaction activity 116 values and the fixed exposure lifecycle 202 particular to IAS 39, it will be apparent to those of skill in the art that the present disclosure is applicable to any suitable values, for example required accounting rule transaction categories 114/transaction activities 116, that may be mapped to custom values, for example custom exposure categories 115/exposure activities 117. The example shown in FIG. 2 is not meant to limit the applicability of the disclosure and disclosed computer-implemented methods, computer-readable media, and computer systems for other suitable uses consistent with this disclosure.

Returning to FIG. 1, in some implementations, the presence, addition, and/or removal of transaction categories 114/exposure categories 116 and/or hierarchical ordering of transaction categories 114/exposure categories 116 and/or transaction activities 116/exposure activities 117 can be based upon at least one ordering rule 118 used by the treasury-risk management module 110 (described below). The order rule 118 may represent policies, conditions, parameters, variables, algorithms, instructions, constraints, references, and any other appropriate information used by the treasury-risk management module 110 to determine hierarchical ordering. In some implementations, the ordering rule 118 can be stored remotely from the ERP server 102 as long as the ordering rule 118 is accessible by the ERP server 102. The ordering rule 118 may be accessed, for example, using a web service, a remote access system or software, a local or remote client 140, or other suitable system component. In some implementations, the ordering rule 118 can be regularly updated to reflect changes in laws, regulations, rules, corporate policies, etc. A change to the ordering rule 118 may trigger an evaluation/re-evaluation of all or a portion of transaction categories 114/exposure categories 116 and/or transaction activities 116/exposure activities 117 by the treasury-risk management module 110.

The business application 108 is any type of application or set of applications that generally allows the requesting, viewing, executing, changing, deleting, generating, or otherwise managing information associated with a business. Generally a business application 108 is used by business users to perform various business-related functions to increase productivity, measure productivity, and perform business functions accurately. Example business applications 108 may include human resources management, payroll management, invoicing, business process development/management, etc. In some implementations, the business application 108 can use business application data (not illustrated) and/or any other suitable data associated with the ERP server 102 and/or other component(s) of the example distributed computing system 100. In some implementations, business application 108 is used to perform flexible exposure lifecycle management in a manner consistent with this disclosure.

The business application data 120 is any type of data associated with and/or used by the business application 108. For example, for a business application 108 that calculates taxes on sales invoices, business application data for a specific sales invoice data object may include data pertaining to a particular sales invoice number, buyer, seller, date, address, product(s), quantity, price, tax rate, etc.

Once a particular business application 108 is launched, a client 140 may interactively process a task, event, or other information associated with the ERP server 102. Business application 108 managed business processes may also include business processes performing and executing business process-related events. Generally, business processes communicate with clients 140, applications, systems, and components to send and receive events.

In some implementations, a particular business application 108 may operate in response to and in connection with at least one request received from other business applications 108, including a business application 108 associated with another ERP server 102. In some implementations, the business application 108 can be and/or can include a web browser. In some implementations, each business application 108 can represent a web-based application accessed and executed by remote clients 140 across the network 130 (e.g., through the Internet, or using at least one cloud-based service associated with the business application 108). For example, a portion of a particular business application 108 may be a web service associated with the business application 108 that is remotely called, while another portion of the business application 108 may be an interface object or agent bundled for processing at a remote client 140.

Any or all of a particular business application 108 may be a child or sub-module of another software module or enterprise application (not illustrated) without departing from the scope of this disclosure. Still further, all or portions of the particular business application 108 may be executed or accessed by a user working directly at the ERP server 102, as well as remotely at a corresponding client 140. Further, although illustrated as a single business application 108, the business application 108 may be implemented as multiple business applications 108 on the ERP server 102.

The treasury-risk management (TRM) module 110 is a service or stand-alone application that provides flexible exposure lifecycle management of exposure categories 115 and/or exposure activities 117 apart from those required by IAS 39 accounting standards. The TRM module 110 allows users to define/create custom exposure categories 115 and/or exposure activities 117, define/create custom exposure lifecycles using predefined and/or custom exposure categories 115 and/or exposure activities 117, create/enter data associated with the transaction categories 114/exposure categories 115 and/or transaction activities 116/exposure activities 117, and/or properly integrate entered transaction category 114/exposure category 115 and/or transaction activity 116/exposure activity 117 data into the appropriate step of the fixed exposure lifecycle 202.

Referring to FIG. 3, FIG. 3 is a block diagram 300 illustrating custom exposure lifecycles defined for different risk categories. A risk category defines a type of risk. For example, foreign exchange rate (FX)—gains/losses due to fluctuations in an exchange rate and commodity (CO)—profits/losses related to a commodity, and interest rate (IR)—gains/losses due to fluctuations in interest rates. As shown in FIG. 3, custom exposure lifecycles 302a and 302b are defined for different risk categories 304a and 304b. For example, Lifecycle A 302a has four defined exposure lifecycle steps (exposure categories 115), “Forecasted Transaction,” “Firm Commitment,” “Asset/Liability,” and “Cash/Stock” for a risk category 304a of “FX.” Note that the “Cash/Stock” lifecycle step is in addition to the three required IAS 39 lifecycle steps. Lifecycle B 302b has three defined exposure lifecycle steps, “Forecasted Transaction,” “Firm Commitment,” and “Cash/Stock” for a risk category 304b of “CO.” Note that the “Cash/Stock” exposure lifecycle step is not necessarily just a rename of the required “Asset/Liability” exposure lifecycle step in IAS 39. If an organization is using IAS 39, both of these lifecycles will need to be mapped to the required transaction categories 114 and/or transaction activities 116 of the fixed exposure lifecycle 202.

Returning to FIG. 2, the TRM module 110 also matches exposure categories 115 and/or exposure activities 117 to one or more of the required IAS 39 transaction categories 114 and/or transaction activities 116. To accomplish this mapping, the TRM module 110 can interface with the mapping table 122. In some implementations, the mapping table 122 can be a database table, flat file, data structure, or the like providing mapping data for the TRM module 110 to process in order to performing mapping functionality. In other implementations, the mapping table 122 can be a stand-alone application (not illustrated), an add-in to another application (not illustrated), for example the business application 108, a business add-in (BADI) (not illustrated), or the like. In some implementations where the mapping table 122 is a stand-alone application or the like, the mapping table 122 may leverage other mapping data external to itself in order to perform the mapping functionality. In some implementations, the mapping table 122 as a particular BADI can assist with hooking customer functionality into the ERP 102 and can be supplied by a third-party or the ERP 102 owner for addition to the ERP 102 of the example distributed computing system 100. Depending on the implementation, the mapping table 122 provides instructions and/or functionality to map exposure categories 115, exposure activities 117, and/or custom exposure lifecycle steps to the required fixed exposure lifecycle 202 of required transaction categories 114 and associated required transaction activities 116 as defined by the IAS 39 accounting standards.

Although illustrated as a single treasury-risk management module 110 in the ERP server 102, two or more treasury-risk management modules 110 may be used in the ERP server 102 according to particular needs, desires, or particular implementations of example distributed computing system 100. The treasury-risk management module 110 can be any application, program, module, process, or other software and may provide methods and a graphical user interfaces to users. In some implementations, a particular treasury-risk management module 110 can operate in response to and in connection with at least one request received from an associated business application 108 and/or client 140. Additionally, a particular treasury-risk management module 110 may operate in response to and in connection with at least one request received from other business applications 108 and/or treasury-risk management modules 110, including business applications 108 and/or treasury-risk management modules 110 associated with another ERP server 102. In some implementations, each treasury-risk management module 110 can represent a web-based application accessed and executed by remote clients 140 using the network 130 (e.g., through the Internet, or using at least one cloud-based service associated with the treasury-risk management module 110). For example, a portion of a particular treasury-risk management module 110 may be a web service associated with a treasury-risk management module 110 that is remotely called, while another portion of the particular treasury-risk management module 110 may be an interface object or agent bundled for processing at a remote client 140. Moreover, any or all of a particular treasury-risk management module 110 may be a child or sub-module of another software module or enterprise application (not illustrated) without departing from the scope of this disclosure. Still further, portions of the particular treasury-risk management module 110 may be executed or accessed by a user working directly at the ERP server 102, as well as remotely at a corresponding client 140.

In some implementations, any and/or all of components of the EPS 102, both hardware and/or software, may interface with each other and/or the interface using an application programming interface (API) 112 and/or a service layer 113. The API 112 may include specifications for routines, data structures, and object classes. The API 112 may be either computer language independent or dependent and refer to a complete interface, a single function, or even a set of APIs. The service layer 113 provides software services to the example distributed computing system 100. The functionality of the EPS 102 may be accessible for all service consumers using this service layer. Software services, such as provide reusable, defined business functionalities through a defined interface. For example, the interface may be software written in JAVA, C++, or other suitable language providing data in extensible markup language (XML) format or other suitable format. While illustrated as integrated components of the ERP server 102 in the example distributed computing system 100, alternative implementations may illustrate the API 112 and/or service layer 113 as stand-alone components in relation to other components of the example distributed computing system 100. Moreover, any or all parts of the API 112 and/or service layer 113 may be implemented as child or sub-modules of another software module, enterprise application, or hardware module without departing from the scope of this disclosure.

The client 140 may be any computing device operable to connect to or communicate with at least the ERP server 102 using the network 130. In general, the client 140 comprises a computer operable to receive, transmit, process, and store any appropriate data associated with the example distributed computing system 100.

The illustrated client 140 further includes a client application 146. The client application 146 is any type of application that allows the client 140 to request and view content on the client 140. In some implementations, the client application 146 can be and/or include a web browser. In some implementations, the client-application 146 can use parameters, metadata, and other information received at launch to access a particular set of data from the server 102. Once a particular client application 146 is launched, a user may interactively process a task, event, or other information associated with the ERP 102. Further, although illustrated as a single client application 146, the client application 146 may be implemented as multiple client applications in the client 140.

The illustrated client 140 further includes an interface 152, a processor 144, and a memory 148. The interface 152 is used by the client 140 for communicating with other systems in a distributed environment—including within the example distributed computing system 100—connected to the network 130; for example, the ERP server 102 as well as other systems (not illustrated) communicably coupled to the network 130. The interface 152 may also be consistent with the above-described interface 104 of the ERP server 102 or other interfaces within the example distributed computing system 100. The processor 144 may be consistent with the above-described processor 106 of the ERP server 102 or other processors within the example distributed computing system 100. Specifically, the processor 144 executes instructions and manipulates data to perform the operations of the client 140, including the functionality required to send requests to the ERP server 102 and to receive and process responses from the ERP server 102. The memory 148 may be consistent with the above-described memory 107 of the ERP server 102 or other memories within the example distributed computing system 100 but storing objects and/or data associated with the purposes of the client 140.

Further, the illustrated client 140 includes a GUI 142. The GUI 142 interfaces with at least a portion of the example distributed computing system 100 for any suitable purpose, including generating a visual representation of a web browser and/or other application. Generally, through the GUI 142, an ERP server 102 user is provided with an efficient and user-friendly presentation of data provided by or communicated within the example distributed computing system 100. In particular, the GUI 142 may be used to view and navigate various web pages located both internally and externally to the ERP server 102 and to perform exposure management functions consistent with this disclosure.

There may be any number of clients 140 associated with, or external to, the example distributed computing system 100. For example, while the illustrated example distributed computing system 100 includes one client 140 communicably coupled to the ERP server 102 using network 130, alternative implementations of the example distributed computing system 100 may include any number of clients 140 suitable to the purposes of the example distributed computing system 100. Additionally, there may also be one or more additional clients 140 external to the illustrated portion of the example distributed computing system 100 that are capable of interacting with the example distributed computing system 100 using the network 130. Further, the term “client” and “user” may be used interchangeably as appropriate without departing from the scope of this disclosure. Moreover, while the client 140 is described in terms of being used by a single user, this disclosure contemplates that many users may use one computer, or that one user may use multiple computers.

The illustrated client 140 is intended to encompass any computing device such as a desktop computer, laptop/notebook computer, wireless data port, smart phone, personal data assistant (PDA), tablet computing device, one or more processors within these devices, or any other suitable processing device. For example, the client 140 may comprise a computer that includes an input device, such as a keypad, touch screen, or other device that can accept user information, and an output device that conveys information associated with the operation of the ERP server 102 or the client 140 itself, including digital data, visual information, or a GUI 142, as shown with respect to the client 140.

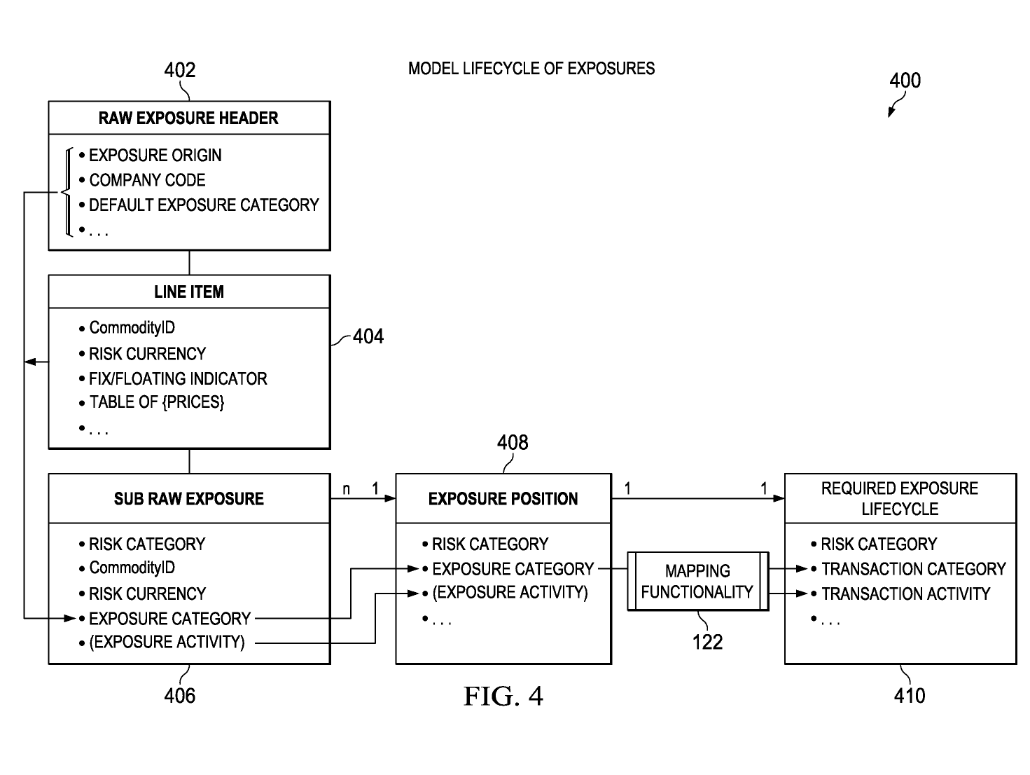

FIG. 4 is a block diagram 400 illustrating a model lifecycle of exposures represented by a data model. The raw exposure header 402 can be thought of as representing a generic exposure, for example an order from an Internet online retailer. At this level, the exposure may be defined by a “Default Exposure Category” of “online order” as an initial proposal for the exposure. The attributes could represent an “Exposure Origin” of a particular type of document received, for example a purchase order/sales order, and a “Company Code” for the online retailer. An additional attribute (not shown) may include an “order ID” for the online order.

The line item 404 represents data further defining the raw exposure (the online order) as defined by the raw exposure header 402. For example, for the online order raw exposure header 402, the line item 404 may represent a line item (e.g. a single book) in the online order for three books (representing three line items). As a further example for the attributes, the commodityID may represent a book, the Risk Currency may represent US dollars, and the Table of Prices may represent variable prices for the line item book (e.g., prices on one date and also on a second date).

The sub raw exposure 406 represents a generated persistency object that can be consumed and reflects a relevant risk category (e.g., commodity risk, foreign exchange risk, interest rate risk, etc.). For each raw exposure line item 404, there can be multiple sub raw exposures 406 generated with regard to risks associated with the line item. For example, for a raw exposure header 402/line item 404 that portrays a future commodity purchase that needs to be made in a foreign currency, the system could create two sub raw exposures 406 (e.g., one for the currency risk and one for the market price risk of the commodity price). A single sub raw exposure 406 could represent, for example, whether part of the order is delivered on one day and part of the overall order delivered on a second date. The sub raw exposure 406 also contains a specific exposure category 115 value and/or an associated exposure activity 117 value. In some implementations, these values may be user-defined and/or automatically determined based on data associated with the raw exposure header 402 and/or the line item 404. Note that there is a n-to-1 correspondence between a sub raw exposure 406 and the exposure position 408. Note that the exposure category/exposure activity attributes may be individually defined for each sub raw exposure 406 and differently than the default exposure category at the raw exposure header 402.

The exposure position 408 is created from one or more aggregated sub raw exposures 406 based upon attributes/rules defining aggregation (not described) and represents an aggregated view of a risk associated with activities related to an operational lifecycle (described below in more detail). The exposure position 408 represents an exposure lifecycle flow of sub raw exposures 408 with a specific “Risk Category” type, for example CO, FX, IR, and the like.

The mapping functionality, for example here a mapping table 122, is used to map the exposure position 408 to a required exposure lifecycle 410, for example in compliance with IAS 39 accounting rules as illustrated in FIG. 2. For example, the “Risk Category,” “Transaction Category,” 114 and “Transaction Activity” 116 for the required exposure lifecycle 410 are determined by the mapping functionality. Note that there is a 1-to-1 correspondence between the exposure position 408 and the required exposure lifecycle 410. In some implementations, the mapping may be performed automatically based upon customizable parameters used by one or more various components of the ERP 102. The customizable parameters may establish thresholds or provide instructions for performing the mapping, ceasing mapping, etc.

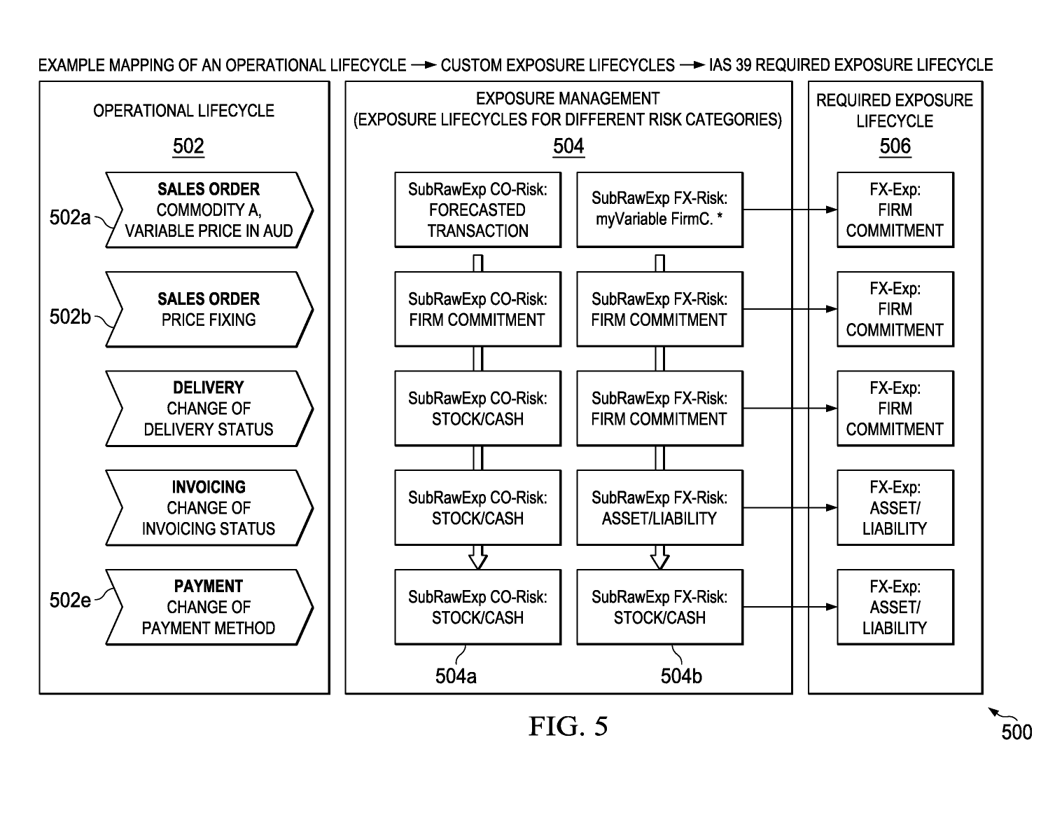

FIG. 5 is a block diagram illustrating an example mapping of an operational lifecycle 502 to a required exposure lifecycle 506, for example fixed exposure lifecycle 202 for IAS 39. Note that FIG. 5 illustrates that the operational lifecycle 502 may be decoupled from the required exposure lifecycle 506 through the use of exposure management 504.

The operational lifecycle 502 represents example business process steps performed by an organization. As shown, the operational lifecycle starts with a sales order 502a with a commodity A and a variable price in Australian dollars (AUD) and proceeds next to a sales order 502b with fixed pricing, and ending after three more operational lifecycle 502 steps at Payment 502e.

The exposure management 504 represents exposure position exposure lifecycles 504a/504b for different risk categories, CO and FX, respectively. For example, for operational lifecycle 502 sales order 502a, two sub raw exposures 406 have been generated (a CO risk category of “Forecasted Transaction” due to commodity A and a FX risk category of “myVariable Firm C.*” due to the variable price in AUD). Similarly, for payment 502e, two sub raw exposures 406 have been generated (a CO risk category of “Stock/Cash” due to a change of payment method and a FX risk category of “Stock/Cash” due to a possible change in currency for payment). Note that for both 502a and 502e, custom exposure lifecycle exposure categories 114 (sub raw exposures) have been defined outside of the required exposure lifecycle required exposure categories.

As illustrated by required exposure lifecycle 506, the exposure management 504 exposure positions 408 are then mapped using the mapping functionality in a 1-to-1 correspondence to the required exposure lifecycle 506. For example, both sales order 502 sub raw exposures represented by the exposure positions 408/exposure lifecycle 504a/504b are mapped to a required fixed exposure lifecycle 202 transaction category 114 of “Firm Commitment” as a “FX” risk category. Any associated exposure activity data 117 associated with the exposure positions 408/exposure lifecycle 504a/504b is likewise mapped to the required fixed exposure lifecycle 202 transaction activity 116 associated with the transaction category 114.

The complete exposure positions 504a/504b are merged and mapped using the mapping functionality into an appropriate required exposure lifecycle 506. Therefore, the operational lifecycle 502 can be mapped to conform to the required exposure lifecycle 506.

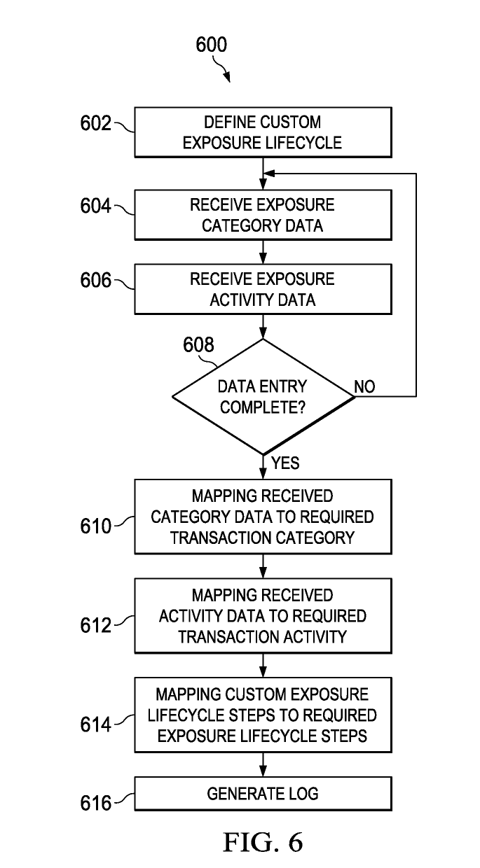

FIG. 6 is a flow chart 600 for flexible exposure lifecycle management. For clarity of presentation, the description that follows generally describes method 600 in the context of FIGS. 1-5. However, it will be understood that method 600 may be performed, for example, by any other suitable system, environment, software, and hardware, or a combination of systems, environments, software, and hardware as appropriate. For example, one or more of the ERP server, the client, or other computing device (not illustrated) can be used to execute method 600 and obtain any data from the memory of the client, the ERP server, or the other computing device (not illustrated).

At 602, a custom exposure lifecycle is defined. The custom exposure lifecycle includes defining the flow of the custom exposure lifecycle by linking together exposure categories (and associated exposure activities) and/or transaction categories (and associated transaction activities).

At 604, category data is received for exposure categories and/or transaction categories. In some implementations, the received category data is for custom exposure categories and does not directly match required transaction categories under IAS 39 accounting standards. From 604, method 600 proceeds to 604

At 606, activity data is received for exposure activities and/or transaction activities. In some implementations, the received activity data is for custom exposure activities and does not directly match required transaction activities under IAS 39 accounting standards. From 604, method 600 proceeds to 606

At 608, a determination is made whether data entry is complete. If at 608 it is determined that data entry is not complete, method 600 proceeds to 604. In some implementations, process flow can proceed to either of 602, 604, or 606 depending upon whether a new custom exposure lifecycle step, exposure category/transaction category, and/or exposure activity/transaction activity is desired or data is to be entered for an existing exposure category/transaction category and/or exposure activity/transaction activity. In some implementations, a system component (not illustrated) may monitor data entry for both 604 and 606 in parallel. If at 608 it is determined that data entry is complete, method 600 proceeds to 610.

At 610, the received category data is mapped with at least one required transaction category of a required exposure lifecycle, so as to ensure compliance with IAS 39 accounting standards. From 610, method 600 proceeds to 612.

At 612, the received activity data is mapped with at least one required transaction activity of a required exposure lifecycle so as to ensure compliance with IAS 39 accounting standards. From 612, method 600 proceeds to 614.

At 614, custom exposure lifecycle steps are mapped with exposure lifecycle steps of a required exposure lifecycle so as to ensure compliance with IAS 39 accounting standards. From 614, method 600 proceeds to 616.

At 616, a log is generated detailing the received data and performed matching. From 616, method 600 stops.

FIGS. 1-6 illustrate and describe various aspects of computer-implemented methods, computer-readable media, and computer systems for flexible exposure lifecycle management. As will be apparent to one of skill in the art, FIGS. 1-6 are only representative examples of many possible implementations and are not meant to limit in any way flexible exposure lifecycle management functionality.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program include, by way of example, can be based on general or special purpose microprocessors or both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method, comprising:
defining at least one custom exposure lifecycle, wherein the at least one custom exposure lifecycle includes at least one custom exposure category and at least one custom exposure activity;
receiving exposure category data associated with the at least one custom exposure category;
receiving exposure activity data associated with the at least one custom exposure activity;
mapping, by operation of at least one computer, the received exposure category data with one of a required set of transaction categories associated with a required exposure lifecycle; and
mapping, by operation of at least one computer, the received exposure activity data with one of a required set of transaction activities associated with the required exposure lifecycle.

2. The method of claim 1, wherein the at least one custom exposure lifecycle includes more or less exposure lifecycle steps than required by the required exposure lifecycle.

3. The method of claim 1, wherein the at least one custom exposure lifecycle is defined for a particular risk category.

4. The method of claim 3, wherein the at least one custom exposure lifecycle is one of a plurality of custom exposure lifecycles defined for a particular operational lifecycle.

5. The method of claim 4, further comprising merging the plurality of custom exposure lifecycles into the required exposure lifecycle.

6. The method of claim 1, further comprising determining whether data entry is complete for the custom exposure lifecycle.

7. The method of claim 1, wherein mapping is performed utilizing at least one of a mapping table, a mapping application, or customizable parameters.

8. A non-transitory, computer-readable medium storing computer-readable instructions executable by a computer to:
define at least one custom exposure lifecycle, wherein the at least one custom exposure lifecycle includes at least one custom exposure category and at least one custom exposure activity;
receive exposure category data associated with the at least one custom exposure category;
receive exposure activity data associated with the at least one custom exposure activity;
map, by operation of at least one computer, the received exposure category data with one of a required set of transaction categories associated with a required exposure lifecycle; and
map, by operation of at least one computer, the received exposure activity data with one of a required set of transaction activities associated with the required exposure lifecycle.

9. The medium of claim 8, wherein the at least one custom exposure lifecycle includes more or less exposure lifecycle steps than required by the required exposure lifecycle.

10. The medium of claim 8, wherein the at least one custom exposure lifecycle is defined for a particular risk category.

11. The medium of claim 10, wherein the at least one custom exposure lifecycle is one of a plurality of custom exposure lifecycles defined for a particular operational lifecycle.

12. The medium of claim 11, further comprising instructions to merge the plurality of custom exposure lifecycles into the required exposure lifecycle.

13. The medium of claim 8, further comprising instructions to determine whether data entry is complete for the custom exposure lifecycle.

14. The medium of claim 8, wherein mapping is performed utilizing at least one of a mapping table, a mapping application, or customizable parameters.

15. A system, comprising:
at least one computer configured to:
define at least one custom exposure lifecycle, wherein the at least one custom exposure lifecycle includes at least one custom exposure category and at least one custom exposure activity;
receive exposure category data associated with the at least one custom exposure category;
receive exposure activity data associated with the at least one custom exposure activity;
map, by operation of at least one computer, the received exposure category data with one of a required set of transaction categories associated with a required exposure lifecycle; and
map, by operation of at least one computer, the received exposure activity data with one of a required set of transaction activities associated with the required exposure lifecycle.

16. The system of claim 15, wherein the at least one custom exposure lifecycle includes more or less exposure lifecycle steps than required by the required exposure lifecycle.

17. The system of claim 15, wherein the at least one custom exposure lifecycle is defined for a particular risk category.

18. The system of claim 17, wherein the at least one custom exposure lifecycle is one of a plurality of custom exposure lifecycles defined for a particular operational lifecycle.

19. The system of claim 18, further comprising instructions to merge the plurality of custom exposure lifecycles into the required exposure lifecycle.

20. The system of claim 15, further comprising instructions to determine whether data entry is complete for the custom exposure lifecycle.

21. The system of claim 15, wherein mapping is performed utilizing at least one of a mapping table, a mapping application, or customizable parameters.

22. A computer-implemented method, comprising:
defining at least one custom exposure lifecycle, wherein the at least one custom exposure lifecycle is one of a plurality of custom exposure lifecycles defined for a particular operational lifecycle; wherein the at least one custom exposure lifecycle includes at least one custom exposure category and at least one custom exposure activity, wherein the at least one custom exposure lifecycle includes more or less exposure lifecycle steps than required by a required exposure lifecycle, and wherein the at least one custom exposure lifecycle is defined for a particular risk category;
merging the plurality of custom exposure lifecycles into the required exposure lifecycle;
receiving exposure category data associated with the at least one custom exposure category;
receiving exposure activity data associated with the at least one custom exposure activity;
determining whether data entry is complete for the custom exposure lifecycle;
mapping, by operation of at least one computer, the received exposure category data with one of a required set of transaction categories associated with the required exposure lifecycle, wherein the mapping is performed utilizing at least one of a mapping table, a mapping application, or customizable parameters; and
mapping, by operation of at least one computer, the received exposure activity data with one of a required set of transaction activities associated with the required exposure lifecycle, wherein the mapping is performed utilizing at least one of a mapping table, a mapping application, or customizable parameters.
